(19) United States
(12) Patent Application Publication
(10) Pub. No.: US 2010/0161537 A1
(43) Pub. Date: Jun. 24, 2010

(54) System and Method for Detecting Email Spammers

(75) Inventors: Danielle Liu, Morganville, NJ (US); Willa Ehrlich, Highland Park, NJ (US); David Hoeflin, Middletown, NJ (US); Anestis Karasaridis, Oceanport, NJ (US)

Correspondence Address: AT & T Legal Department - WS;Attn: Patent Docketing, Room 2A-207, One AT & T Way, Bedminster, NJ, 07921, US

(73) Assignee: AT&T Intellectual Property I, L.P., Reno, NV (US)

(21) Appl. No.: 12/418,980

(22) Filed: Apr. 6, 2009

Related U.S. Application Data
(63) Continuation-in-part of application No. 12/342,167, filed on Dec. 23, 2008, now abandoned.

(51) Int. Cl. G06N 5/02; G06F 15/16

(52) U.S. Cl. 706/46; 709/206; 709/224

(57) ABSTRACT

A system and method for detecting Email spammers from unknown SMTP Clients using the unknown SMTP Client's SMTP traffic information e.g. byte size and variability data. The system and method includes a byte size and variability traffic flow model and a classification system. The traffic flow model may be based upon a standard deviation of byte size and variability of traffic flows for a plurality of legitimate SMTP Clients and for a plurality of Spammer SMTP Clients. The classification system then classifies an Unknown SMTP Client as an Email Spammer based on a comparison between the byte size and the variability of the Unknown SMTP Client's traffic flows with the byte size and variability traffic flow model.

This application is a continuation-in-part of prior application Ser. No. 12/342,167 filed Dec. 23, 2008 which is herein incorporated by reference.

### FIELD

The disclosed technology relates to a system and method for detecting SMTP Clients who initiate spam email, and more specifically, to a traffic-based approach for email spammer detection.

### BACKGROUND

E-mail spam, also known as unsolicited bulk E-mail or unsolicited commercial E-mail, is unwanted E-mail messages that are frequently sent with commercial content in large quantities to an indiscriminate set of recipients. Spam E-mail initially became problematic in the mid-1990s when the Internet was opened up to the general public and, subsequently, it has grown exponentially. Currently, E-mail spam comprises between 80 to 85% (and perhaps as high as 95%) of all E-mail.

Spam is delivered the same way as legitimate E-mail. Thus, both may utilize the Simple Mail Transfer Protocol (SMTP) which enables one system to transfer mail to another system on the same or on a different network via relay or gateway processes accessible to both networks. Specifically, after an E-mail is composed, the sender injects the E-mail into the network by submitting the E-mail to a Mail Transfer Agent (MTA) that assumes responsibility for delivering the sender's E-mail to its final destination. The MTA, in turn, relays the E-mail to additional hosts within the same system, thereby allowing E-mail to be aggregated within the administrative network. At some point, one of the MTA's in the sender's administrative network will identify a host responsible for receiving E-mail in the recipient's administrative network and relay the E-mail to the host in the other network. This latter host may be an intermediate host, in which case it will either relay the E-mail internally via SMTP within the recipient's administrative network, or else act as a gateway to transport the message using a protocol other than SMTP. The latter host may also deliver the E-mail directly to a local mailbox for the recipient.

E-mail spammers usually relay E-mail through MTAs called open relays. The open relays accept responsibility for delivering E-mail from unauthenticated IP hosts. Thus, these open relays will themselves be able to be authenticated and authorized to submit mail by receiving MTAs. Alternatively, spammers can also employ compromised machines, called Botnet hosts, to run MTA software and hence be used as mail relays to directly send E-mail to MTA's in target destination domains.

Current approaches to detect/mitigate spam include email payload content filtering. In content filtering, the header and body of an email are analyzed for certain keywords, patterns (e.g., URL strings), message signatures, and message authentication policies that are characteristic of email spam. In the case of content filtering, blocking rules need to be updated frequently and new spam corpuses must be used for re-training (if the keywords are learned dynamically by means of a Bayesian filter) as spammers devise new content and formats to circumvent the filters.

Another approach is address-based filtering. In address-based filtering, the originating IP address and session establishment data are analyzed for reputation, domain signature, connection authentication policy, session signature, protocol, traffic and connection limits. IP addresses of spam email clients are entered into centrally maintained databases such that MTAs can reject or throttle all mail either originating from or relayed by a listed host. Various Black Lists of spam sources have been compiled that can lead E-mail to be rejected based on the IP address of the sending Host. A black list is a list of e-mail addresses of known spammers. Conversely, a white list is a list of “from” e-mail addresses that a mail server is configured to accept as incoming mail. Address-based filtering may filter messages that are black listed, white listed or both. Systems that rely entirely on white lists, however, are severely restricted because only messages from addresses on the list are allowed, and all the rest are discarded. Some black list are called Realtime Blackhole Lists (RBLs) or, if accessible via the Domain Name System (DNS), DNS Black Lists or DNSBLs. These lists are accessed by MTAs during the relay of E-mail messages or they can be accessed by programs such as Spam Assassin when mail is filtered into mail boxes during final delivery.

In the case of address-based filtering, adding IP addresses of spamming SMTP clients in a blacklist is meaningful only if such addresses are largely static and persist over time and if only a small fraction of spamming SMTP clients utilize dynamic or short lived IP addresses. However, if spammers use addresses without reputation (e.g., when the proportion of spam email from dynamic addresses is significant or if low-volume spamming occurs from spammers who are compromised hosts), then an address based filtering approach based on blacklists will be less effective.

System administrators must also ensure that these lists are modified when: E-mail Clients become Spammers, when E-mail Clients are incorrectly labeled as Spammers and when E-mail Spammers are rehabilitated from being spammers (e.g., after a malware cleanup). As spam sources become more short-lived, a blacklisting approach to spam detection may become less effective in the future.

Another approach is a social network based approach to spam detection. This approach applies a graph-theoretic analysis to interactions between E-mail addresses that communicate via a user to construct an E-mail user's personal E-mail network. The algorithm first identifies a node referencing addresses appearing in E-mail headers of messages within a user's inbox. Edges between Sender A and Recipient B are created for pairs of addresses in the same header. (For example, if A sent a message to both B and C as well as to User U, then there will be a link between A and U; A and B; and A and C.) In a social network, if A knows B and C, then B is likely to know C. Hence, it is expected that a pair of a User's neighbors will also be connected by an edge (i.e., neighbors sharing neighbors) and so there will be a region within a User's personal E-mail network graph with a high clustering coefficient.

In contrast, in a spam sub-network, no node shares nodes with any of its neighbors (i.e., if Spammer S sends E-mail to user U and to B and C, then U, B and C are not likely to know one another) and hence will exhibit a low clustering coefficient. Thus, by generating a personal E-mail network for each user as their mail servers receive E-mail, individual E-mail User White Lists and Black Lists can be constructed. However, because this approach requires the sender's E-mail address and the list of recipient E-mail addresses for all the messages in a user's inbox, it is highly invasive.

Another approach is a graph-theoretic approach for differentiating Legitimate E-mail Client MTAs, that submit SMTP traffic to legitimate Server MTAs only, from. Spammer E-mail Clients that submit SMTP traffic both to legitimate Server MTAs and to machines that do not typically receive SMTP traffic. This approach assumes that there exists a set of nodes representing Client MTAs that initiate SMTP traffic and another set of nodes representing Server MTAs that receive SMTP traffic and that together these nodes form a bipartite sub-graph.

Although both Legitimate E-mail Client MTAs and Spammer E-mail Clients tend to have high outgoing traffic, a Legitimate E-mail Client MTA will send E-mails only to legitimate Server MTAs while an E-mail Spammer will send E-mail to all machines. Under this approach an adjacency matrix may be constructed between nodes and a recursive Hyper-link Induced Topic Search (“HITS”) algorithm is then applied to derive a set of client weights and a set of server weights for nodes in the adjacency matrix. A node's client score will be higher if it submits E-mail to many nodes with high server weights while a node's server weight will be higher if it receives E-mail from many nodes with high client weights. Hosts with high client weights, but that also send E-mail to machines with low server weights, are considered to be most likely to be performing spamming.

Since the adjacency matrix can be constructed based on SMTP transport header data, there is minimal privacy intrusion. However, construction of an accurate adjacency matrix can be problematic since it is dependent on a network's view of the Internet. Furthermore, the assumption that a Spammer will also send SMTP traffic to “illegitimate” E-mail Servers may not be warranted.

An approach that attempts to deny resources to E-mail spammers and that can be implemented at the Router level is the rate-limiting approach. SMTP traffic arriving at a Router is intercepted for subsequent analysis. The first stage of the algorithm attempts to match the contents of each new incoming E-mail message against a cache of recently-observed candidate messages so as to classify a message as part of a bulk E-mail stream or as possessing unique content. If a bulk E-mail stream is detected, then the second stage of their algorithm employs a Bayesian classifier to determine whether the bulk E-mail stream is spam.

If the estimate of “spamminess” is greater than a threshold value, the E-mail stream is declared as spam and its delivery is rate-limited by resetting the TCP session when the elapsed time between consecutive arrivals is less than a minimum delay threshold. Such an approach also relies on content filtering; hence, Spammers are able to modify E-mail message content in response to users updating content filters.

As mentioned above, content-based analysis of an E-mail message's subject and message body using both an appropriately trained Bayesian filter and dynamic static rules, has been demonstrated to filter a very high proportion of spam. However, such content analysis results in a high degree of privacy intrusion. Furthermore, system administrators must continuously update their rule sets in order to ensure that content filtering remains effective.

### SUMMARY

The disclosed technology involves an approach for detecting SMTP Clients who send email spam based on traffic characteristics of, e.g., Simple Mail Traffic Protocol (SMTP). The traffic characteristics are derivable from SMTP transport header data from a plurality of spam and legitimate SMTP traffic sources.

The email Spammer detection system includes a byte size and variability traffic flow model and a classification system. The byte size and variability traffic flow model may define: a mean byte size for traffic flows associated with a plurality of legitimate SMTP Clients; a mean byte size for traffic flows associated with a plurality of Spammer SMTP Clients; a standard deviation in byte size for traffic flows associated with a plurality of legitimate SMTP Clients; a standard deviation in byte size for traffic flows associated with a plurality of Spammer SMTP Clients; a multivariate traffic vector based on a mean byte size and a standard deviation in byte size for traffic flows associated with a plurality of plurality of legitimate SMTP Clients; and/or a multivariate traffic vector based on a mean byte size and a standard deviation in byte size for traffic flows associated with a plurality of plurality of Spammer SMTP Clients. Once the byte size and variability traffic flow model is established, the classification system classifies an SMTP Client as an Email Spammer, a legitimate SMTP Client or unclassifiable based on the SMTP Client's incoming traffic flows by comparing an SMTP Client's incoming traffic flow's byte size and variability with the byte size and variability traffic flow model. That is, the classification system extracts, using an extractor, the SMTP Client IP address, byte size and the variability from traffic header information associated with an incoming traffic flow. A comparator then compares the byte size and the variability of the SMTP Client's incoming traffic flows with the byte size and variability traffic flow model. Based on the results of the comparison, the classification system uses a classification algorithm to classify the SMTP Client based on incoming traffic flows. SMTP Clients that are classified as E-mail Spammers may be black listed. Traffic flows associated with SMTP Clients classified as E-mail Spammers may be filtered from the messaging system.

To further enhance the detection system, a traffic model adjustor may be used to adjust the byte size and variability traffic flow model based on a periodicity effect. This is done using a smoothing technique to smooth the byte size and variability traffic flow model.

### BRIEF DESCRIPTION OF THE DRAWINGS

FIG. 1 illustrates the distributions of SMTP traffic for black listed v. white listed clients;

FIG. 2 illustrates the distributions statistics for black listed v. white listed clients;

FIG. 3 illustrates traffic model parameters for a given SMTP client category;

FIG. 4 is high-level block diagram of a computer for implementing the disclosed technology;

FIG. 5 is a flow chart illustrating an exemplary use of the disclosed technology;

FIG. 6 is a block diagram of an exemplary design of the disclosed technology;

FIG. 7 illustrates scatter plots of traffic parameter values;

FIG. 8 illustrates SMTP model accuracy as a function of time;

FIG. 9 illustrates an evaluation of SMTP model classification accuracy; and

FIG. 10 illustrates scatter plots of traffic model accuracy as a function of day of week and time of day.

### DETAILED DESCRIPTION

The disclosed technology recognizes that spammers possess the capability to alter the content of their E-mail messages in response to content filtering. But the fact that spam generation and transmission are typically automated results in spammers having far less flexibility in varying the traffic characteristics of their E-mail messages. Statistical analysis of the distribution of E-mail message size originating from spam vs. legitimate E-mail Clients indicates that the sizes of the legitimate E-mails are much more variable and have a heavier tail with spam messages exhibiting both lower average E-mail message size and less variation in E-mail message size. Accordingly, such traffic characterizations are less likely to be alterable by sophisticated spammers so that a traffic-based approach might be expected to be fairly robust in differentiating legitimate SMTP Clients from Email Spammer SMTP Clients. In the disclosed technology we base our characterizations upon SMTP traffic flows but the disclosed technology is not limited to SMTP traffic but any traffic protocol, e.g., Local Mail Transfer Protocol (LMTP) et al., can be analyzed using the disclosed technology.

A SMTP traffic flow is used to transmit an email message from a sender side to a receiver side. The traffic flow is formed by breaking an email message into a set of packets with each packet containing transport header data. The transport header data contains information to track each packet such as source and destination IP addresses, protocol types, source and destination ports as well as other related information. These packets are then individually transmitted from the sender side to the receiver side. Once on the receiver side receives all the packets, the receiver side uses the transport header data to reassemble the packets into the original email message. The message is then sent to the receiver's mailbox.

The disclosed technology uses the SMTP traffic flow to detect E-mail Spammers. Specifically, the disclosed technology is an alternate approach to E-mail spammer detection based on traffic characteristics of SMTP traffic using transport header data of Email Spammers vs. legitimate SMTP Clients. In order to detect Email Spammers, traffic flow models of Email Spammers vs. legitimate SMTP Clients are formulated using the mean and standard deviation of each SMTP Client type's traffic characteristics (e.g., byte size and variability of SMTP flows) for a plurality of E-mail Spammers and a plurality of legitimate SMTP Clients. These traffic flow models are then used to compare traffic header data of SMTP traffic flows initiated by an SMTP Client to the traffic flow models.

### The Byte Size and Variability Traffic Flow Model

The E-mail spammer detection of the disclosed technology analyzes the byte size and variability of traffic flow data associated with a plurality of known legitimate email sources and with a plurality of known spammer email sources. These traffic flow data was chosen based on carefully considered criteria laid out below. The traffic flow data are then used to create a byte size and variability traffic flow model for use in determining if an unknown SMTP client is an Email Spammer.

Specifically, the byte size and variability traffic flow model may be a multivariate model based on SMTP traffic flows composed of one or more packets between two Internet Hosts. The model was defined by a set of Black and White Lists that were in effect for a given calendar date/hour. Using these Black and White Lists, SMTP traffic flows traversing a diverse set of peering links for a set of known E-mail Spammers and a set of known Legitimate E-mail Clients during a given hour are collected.

A SMTP Client is defined as the MTA in the initiating Peer Autonomous System or AS (i.e., Tier 1 Internet Service Provider or ISP) that initiates an SMTP connection using a local ephemeral port and an E-mail Server as the MTA in the receiving Peer AS (Tier 1 ISP) that accepts the SMTP connection on port 25.

In the event of resource limitations, peering links are prioritized with respect to the amount of SMTP traffic carried for these specific SMTP Clients and then flow data collection is terminated upon reaching 50% of the total SMTP traffic flows for these particular SMTP Clients.

Given that numerous SMTP transport header traffic variables could potentially differentiate these two groups of E-mail Clients (e.g., proportion of flow requests with SYN Only flag initiated by SMTP Clients to SMTP Servers; proportion of flow responses with RESET Only flag from SMTP Servers to SMTP Clients), it is important to retain E-mail Clients who initiate both a “sufficient” number of SMTP flow requests (to SMTP Servers) and who received a “sufficient” number of SMTP flow responses (from SMTP Servers). Consequently, for these identified E-mail Spammers and Legitimate E-mail Clients, it was recommended that they initiate >50 SMTP flow requests and that they receive >50 SMTP flow responses in order to be included for subsequent traffic modeling. This SMTP flow request value is merely recommended and may be adjusted based on various implementations.

To ensure that SMTP requests are useful (as opposed to, for example, scans to destination TCP port 25 or incomplete 3-way handshakes), PUSH-flag enabled flows are analyzed. (A PUSH flag is a notification from the sender to the receiver for the receiver to push both the current packet data plus other packet data that the receiving TCP has collected, to the receiving application process. Thus, by considering PUSH flags enabled flows, only flows representing data transfers are analyzed.)

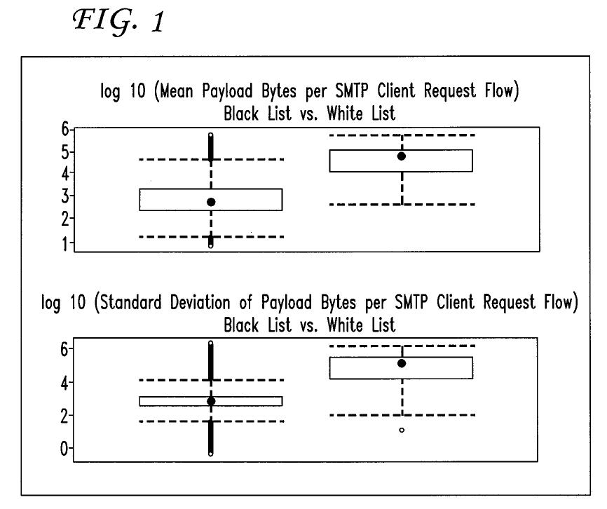

FIG. 1 indicates that for client-initiated outbound flows containing PUSH flags, the distributions of E-mail message size (i.e., number of payload bytes within a flow) originating from Black listed vs. White listed E-mail Clients are distinguishably different. Specifically, the payload byte sizes of SMTP request flows of the White listed SMTP Clients are much more variable and have a heavier tail than the sizes for Black listed SMTP Clients.

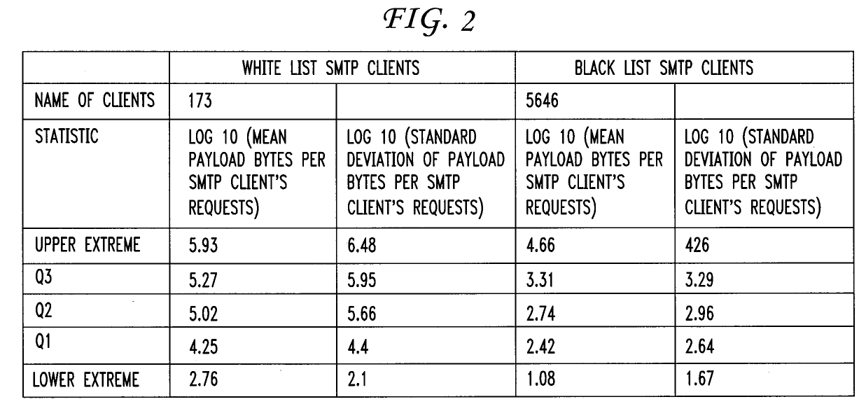

In contrast, the Black listed SMTP Clients exhibit both lower average payload byte size of SMTP request flows and less variation in these flows' payload byte sizes. Consequently, traffic models of client-initiated SMTP traffic flows can be derived to distinguish SMTP flow traffic behavior associated with Spammers vs. legitimate E-mail Clients. Summary statistics for the distributions of these two traffic characteristics for the two categories of E-mail Client are given in FIG. 2.

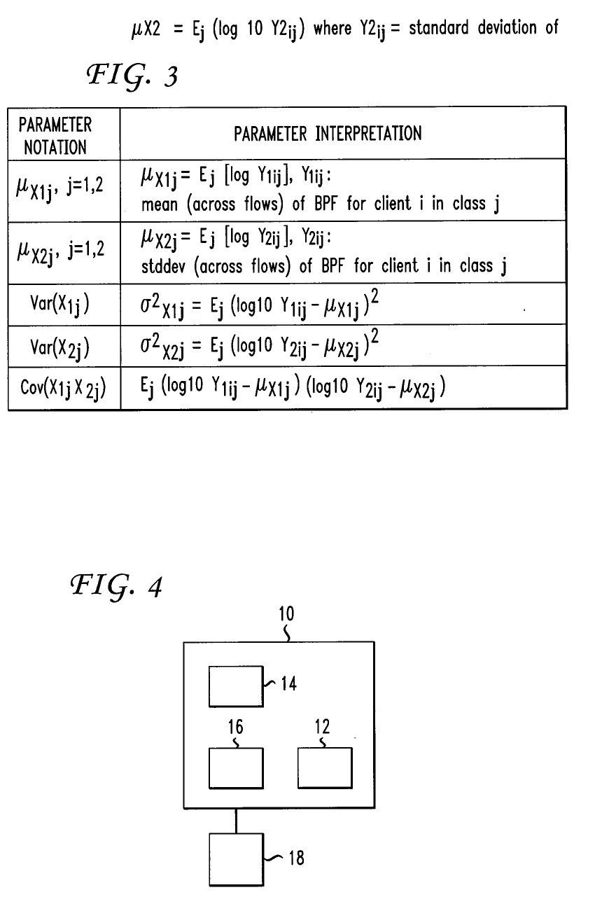

For a given type of SMTP Client, Black Listed vs. White Listed, there are, at a minimum, 5 parameters that define the SMTP traffic model. These parameters are presented in FIG. 3.

In order to utilize the above traffic characteristics, multivariate models of “known” spammer E-mail Clients and “known” legitimate E-mail Clients are derived. The model is based on SMTP request traffic based on the mean and standard deviation of these SMTP Clients' outbound” SMTP flows (i.e., a one-way connection involving a local TCP ephemeral Port and remote TCP Port 25).

An exemplary formulation of a traffic vector is shown below:

Consider a vector X composed of p random variables. The random vector X=[X₁, X₂, . . . , Xₚ] has a p-dimensional multivariate normal distribution if its density is given by

f(X)=(1/(2π)^{p/2}|Σ|^{1/2})exp(−((X−μ)^{T}Σ⁻¹(X−μ))/2) (1)

where Xᵢ are random variables, μ=E[X] is the expected value of X and Σ=E[(X−μ)(X−μ)^{T}] is the covariance matrix of X with rank p.

Now, consider a multivariate data sample (i.e., observation), x=[x₁, x₂, . . . , xₚ]. Assume that there are J known classes of interest. Let C={c₁, c₂, . . . , cⱼ } represent the set of all known classes. The notation C(x)=cⱼ means that the measured data sample x belongs to class cⱼ.

A Bayesian statistical decision about the class cⱼ of an observation is based on P(cⱼ/x), the probability of class cⱼ conditional on the observation x, known as the posterior probability. From the Bayes Theorem, we have:

P(C(x)=cⱼ)=P(cⱼ/x)=P(cⱼ)*P(x/cⱼ)/P(x) (2)

where P(cⱼ) denotes the probability of class cⱼ independently of the observed data (the prior probability) and P(x/cⱼ) is the conditional distribution function of the traffic data vector x given it is in class j.

Since the denominator in (2) does not depend on the category, a Bayes decision rule classifies an observation into category cⱼ whenever

C(x)=arg max P(cⱼ)*P(x/cⱼ) (3)

For the special case J=2, a decision can be made if

P(C(x)=cⱼ)(P(cⱼ)*P(x/cⱼ))/(Σ²ⱼ₌₁P(cⱼ)*P(x/cⱼ))>T, (4)

where T>0.5.

In the current context, (4) is equivalent to classifying an SMTP client as email spammer whenever:

P(C(x)=c_{S})=(P(c_{S})*(P(x/c_{S}))/(P(c_{S})*(P(x/c_{S})+(P(c_{L})*P(x/c_{L}))>T (5)

where c_{S} and c_{L} denote the spammer and legitimate classes, respectively. By varying T, one can allow for less false positives (incorrectly classifying legitimate clients as spammers) at the expense of fewer true positives (i.e., correctly classifying spammers) or vice versa. Since we do not have bias for either class, we assign equal prior probabilities to the two classes (i.e., P(c_{S})=P(c_{L})), and so we can write (5) as:

P(C(x)=c_{S})=P(x/c_{S})/((Px/c_{S})+P(x/c_{L}))>T (6)

The probabilities P(x/cⱼ) are calculated from (1) based on the (bi-variate) normal mean value vectors and covariance matrices constructed from traffic data on the two differentiating traffic variables.

A value of T=0.8 can be used but this value is merely recommended and may be adjusted based on various implementations.

### Specific Embodiment

In a specific embodiment, traffic characterizations, such as those described above, are established based on traffic flow data such as Netflow-type data. Such data corresponds to Internet Protocol (IP) transport header data and represents far less intrusive data than IP payload information. In addition, traffic characterizations should be applicable to both dynamic IP addressing where the spamming host's IP mapping can change within several hours as well as to spamming hosts that initiate a low volume of spam traffic for the purpose of avoiding detection.

A high-level block diagram of a computer for implementing the disclosed technology is illustrated in FIG. 4. Computer 10 contains a comparator 12 which controls the overall operation of the computer by executing computer program instructions which define such operation. The computer program instructions may be stored in a storage device 14, or other computer readable medium (e.g., magnetic disk, CD ROM, etc.), and loaded into memory 16 when execution of the computer program instructions is desired. Thus, the steps discussed below can be defined by the computer program instructions stored in the memory 16 and/or storage device 14 and controlled by the comparator 12 executing the computer program instructions. For example, the computer program instructions can be implemented as computer executable code programmed by one skilled in the art to perform an algorithm defined by the steps discussed below. Accordingly, by executing the computer program instructions, the comparator 12 executes an algorithm defined by these steps. The computer 10 also includes one or more network interfaces for communicating with other devices via a network and may also include input/output devices 18 that enable user interaction with the computer (e.g., display, keyboard, mouse, speakers, buttons, etc.). One skilled in the art will recognize that an implementation of an actual computer could contain other components as well, and that FIG. 4 is a high level representation of some of the components of such a computer for illustrative purposes.

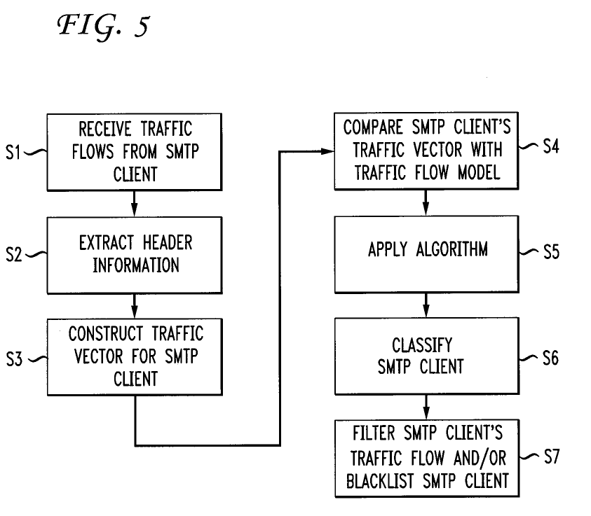

FIG. 5 is a flow chart of steps that implement the disclosed technology. In use, after the system receives incoming SMTP traffic flows initiated by a SMTP client for a given unit of time S1, traffic data are extracted from the traffic header information associated with the SMTP Client's incoming traffic flows S2. A traffic vector is then constructed for each SMTP Client representing an SMTP Client's mean SMTP request flow size (in number of bytes) and/or the standard deviation of the byte sizes of the SMTP request flows S3.

Once an E-mail Client's traffic vector is obtained, the system compares the mean value traffic vector of each of the two categories of SMTP Clients S4. A classification algorithm is then applied to the results of the comparison S5. Based on the results of the classification algorithm, the SMTP Client is classified S6. The traffic flows initiated by the SMTP Client may then be sent to a filter S7 or the SMTP Client may be black listed from the messaging system.

E-mail Clients may be classified as either “Spammer” or “Legitimate” or “Unclassified.” That is, the probability of an “Unknown” E-mail Client being a Spammer given his/her traffic vector (i.e., the posterior probability or probability of a category conditionalized on the observed traffic vector) is computed based on the prior probabilities of spammer Client and legitimate Client occurrences (irrespective of the observed traffic vector) together with the probability densities of the traffic vector given the two multivariate traffic models. Based on the probability, a decision rule is then applied to these values to classify an E-mail Client as “Spammer”; “Legitimate” or “Unclassified” S6. The traffic-based approach to E-mail Spammer detection of the disclosed technology may compliment both content-based and IP address-based filtering approaches as well as “resource starvation” approaches to E-mail spam detection. Thus, upon being classified as a Spammer, an “Unknown” E-mail Client can subsequently receive fewer resources or be ranked at lower priority with respect to additional mail processing. Furthermore, since this traffic-based approach can be applied to IP transport header data, it entails a minimal degree of privacy intrusion.

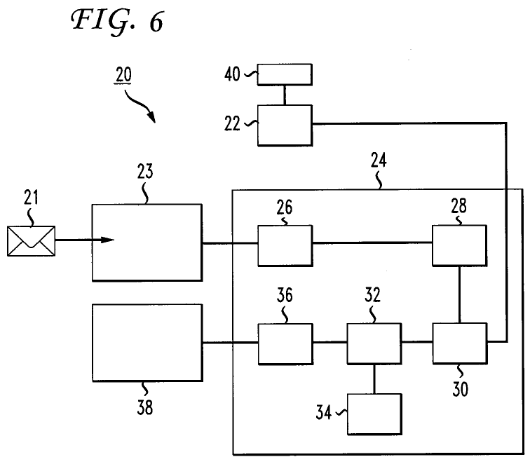

FIG. 6 shows a specific embodiment for the disclosed technology. The E-mail Spammer detection system 20 includes database 22 containing a byte size and variability traffic flow model and a classification system 24. The database 22 contains the byte size and variability traffic flow model which represents byte size and variability for a plurality of legitimate SMTP Clients and a plurality of Email Spammers. The byte size and variability traffic flow model may define: a mean byte size for traffic flows associated with a plurality of legitimate SMTP Clients; a mean byte size for traffic flows associated with a plurality of Spammer SMTP Clients; a standard deviation in byte size for traffic flows associated with a plurality of legitimate SMTP Clients; a standard deviation in byte size for traffic flows associated with a plurality of Spammer SMTP Clients; a multivariate traffic vector based on a mean byte size and a standard deviation in byte size for traffic flows associated with a plurality of plurality of legitimate SMTP Clients; and a multivariate traffic vector based on a mean byte size and a standard deviation in byte size for traffic flows associated with a plurality of plurality of Spammer SMTP Clients.

Once the byte size and variability traffic flow model is established and stored, the classification system 24 classifies a SMTP Client initiating SMTP traffic flows 21 that are received by a network MTA 23 as an Email spammer, a legitimate SMTP Client or unclassifiable by comparing the SMTP Client's incoming traffic flows' byte size and variability with the byte size and variability traffic flow model. That is, incoming traffic flows initiated by a SMTP client for a given unit of time 21 will be received in an MTA 23. The classification system 24 then extracts, using an extractor 26, the byte size and the variability from traffic header information associated with the SMTP Client's incoming traffic flows 21. A vector construction device 28 then constructs a traffic vector for the SMTP Client using the extracted traffic header information associated with the SMTP Client's incoming traffic flows 21. A comparator 30 then compares the traffic vector of the SMTP Client's incoming traffic flows 21 with the byte size and variability traffic model. Based on the results of the comparison, a processor 32 uses a classification algorithm stored in a storage device 34 to classify the SMTP Client based on his/her incoming traffic flows 21. Traffic flows associated with SMTP Clients classified as E-mail Spammers may be filtered from the messaging system using a filter 36 and traffic flows associated with SMTP Clients classified as legitimate may be sent to a user's mailbox 38. (Please note, the steps involved in transforming the SMTP traffic flows into a decipherable email message are not shown but any device that is known to one skilled in the art may be used to transform the traffic flows into the original email message.) Additionally, filtered SMTP flows may be deleted from the system, source IP addresses may be added to a Black listed and/or the email message and its associated traffic flows may be sent to a spam email folder where the network may further analyze the spam message/SMTP traffic flows.

### Smoothing

To further enhance the detection system, a traffic model adjustor 40 may be used to adjust and/or update the traffic flow model based on a periodicity effect. This is done using a smoothing technique to smooth the traffic flow model.

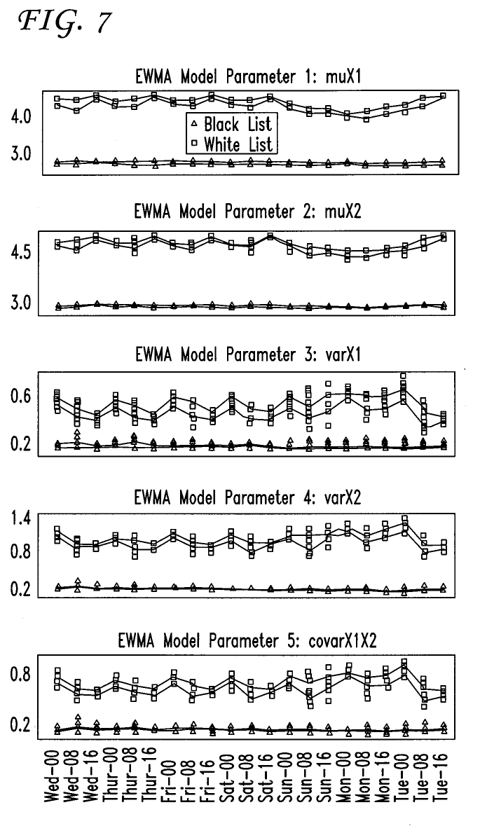

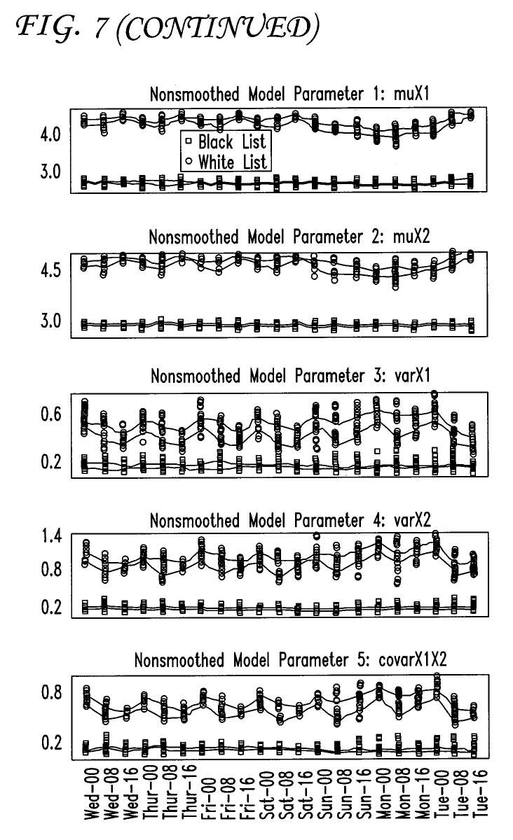

FIG. 7 shows the scatter plots of traffic models' parameter values as a function of day of week and hour of day for two categories of SMTP Clients. The left panel represents model parameter values that were smoothed using Exponential Weighted Moving Average (EWMA) while the right panel represents unsmoothed model parameter values. Preliminary time series analyses of these parameter values by SMTP Client type indicated that a periodicity effect existed for SMTP traffic initiated by legitimate SMTP Clients. This is demonstrated in the right panel of FIG. 7 which presents a scatter plot of traffic model parameter values as a function of hour of day and day of week. Dashed lines indicate median parameter values while solid lines indicate the 25th and 75th quartile parameter values. The right panel is consistent with finding that traditional E-mail arrival exhibits a daily cycle and thus has high rates of arrival during certain times of day in contrast to the more homogeneous rate of arrival of spam E-mails.

For Legitimate SMTP Clients, both the expected average SMTP request flow payload bytes size (muX1) and the expected standard deviation in SMTP request flow payload bytes size (muX2) are greatest at 16:00 UTC (Universal Time Coordinated) time with the exception of Sunday. In contrast, both the variances and covariance (i.e., varX1; varX2; covarX1X2) of these two SMTP message size characteristics are lowest at 16:00 UTC time, again with the exception of Sunday. These types of patterns are much less pronounced for the Black Listed SMTP Clients. Thus, spammers who use automated tools to generate E-mail efficiently try to spread these messages uniformly throughout the day so in order to avoid detection. Legitimate SMTP Clients, on the other hand, initiate E-mail for social reasons and hence their E-mail communications are driven by their work/leisure profiles. The time of day and day of week effects for legitimate SMTP Clients in their expected SMTP flow payload byte size and their expected SMTP flow payload byte size variation would also appear to represent the effect of work/leisure considerations on E-mail interactions.

Given the existence of periodicity effect associated with time of day and day of week, a seasonality cycle of 1 week duration corresponding to 21 successive 8-hour time periods can be characterized. A set of traffic model parameter values for a given SMTP Client type for each of these 21 time periods (corresponding to a week duration) and apply a moving average procedure to smooth short-term fluctuations associated with model parameter values may be defined. These time periods may be adjusted based on various implementations.

Specifically, given a data point, Y(t), which, in the current context, represents a traffic model parameter value calculated for a given SMTP Client of category j for the t^{th} time period corresponding to the current day of week and time of day, an estimate of the model parameter value can be calculated. The model parameter value, S(t), can be used as the expected (and smoothed) value for the t+21 time period, using exponentially weighted moving average (EWMA), as follows:

S(t)=α*Y(t)+(1−α)*S(t−21),t≧22; 0≦αS≦1.0 (6)

Note that Y(t) corresponds to the observed or calculated parameter value at time period t while S(t) corresponds to the value of the EWMA at time period t to be applied to time period t+21. Thus, S(t), t=1, 2, . . . 21, is undefined whereas S(t), t=22, 23, . . . , 42 is initialized by setting S(t) to Y(t−21).

The EWMA filter gives higher weights to more recent observations by weighting older observations by increasing powers of 60 . The larger the value of α, the more important the current observation, Y(t) and the less important the older observations. Thus, when α is set to 1, no filtering is performed and S(t)=Y(t). Alternatively, when α is set to 0, the degree of filtering of the current observation is so great that measurement is not involved in the calculation of S(t) and S(t)=S(t−1). Since no sudden fluctuations in these parameter values were anticipated, a was set to 0.5 but other settings may be used.

For a given time of day and day of week, for model parameters muX1, muX2, varX1 and varX2, the effect of the EWMA filtering is to reduce the variation in model parameter values (i.e., reduce the model parameter's inter-quartile range or the difference between the model parameter's upper quartile and the model parameter's lower quartile) so that the 2 populations of SMTP Clients are more distinguishable.

Consequently, the EMWA parameter values are utilized when evaluating the accuracy of the traffic models in classifying Black Listed and White Listed SMTP Clients. The following four metrics were used to evaluate model classification accuracy:
P(Classified Spammer/Black Listed SMTP Client): the ratio of correctly classified Email Spammers to all Black listed SMTP Clients.
P(Classified Legitimate/Black Listed SMTP Client): the ratio of Black listed SMTP Clients incorrectly classified as Legitimate to all Black listed SMTP Clients.
P(Classified Legitimate/White Listed SMTP Client): the ratio of correctly classified Legitimate SMTP Clients to all White Listed SMTP Clients.
P(Classified Spammer/White Listed SMTP Client): the ratio of White listed SMTP Clients incorrectly classified as Spammer to all White Listed SMTP Clients.

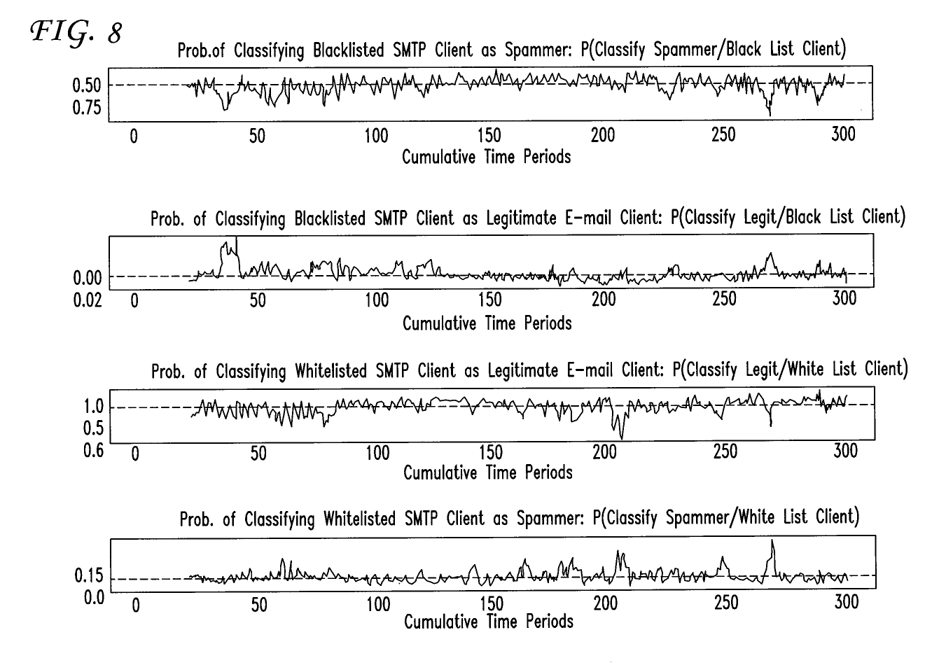

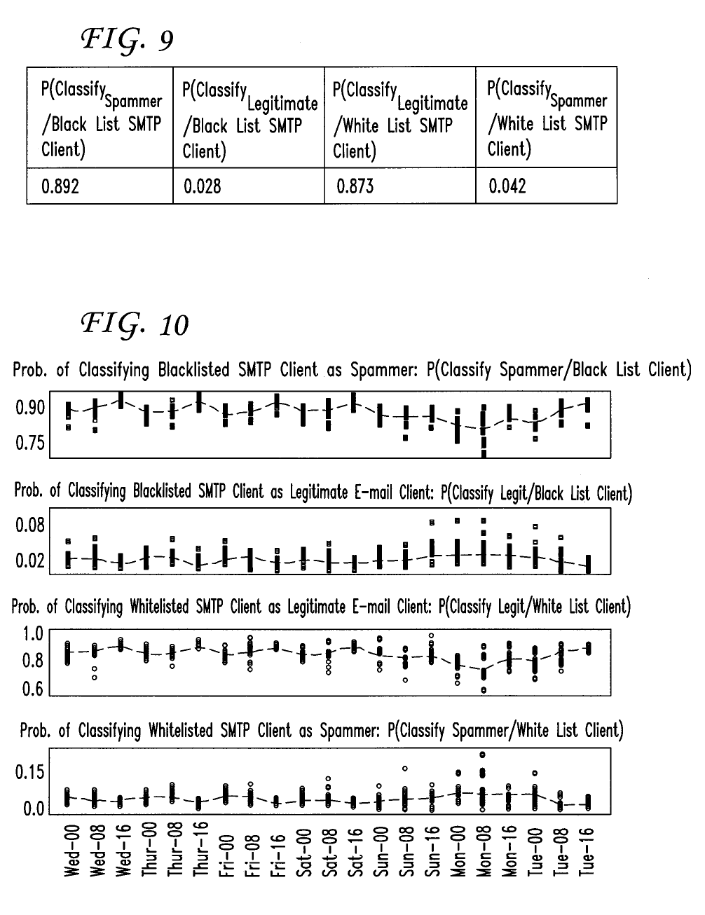

FIG. 8 presents time series of each of these 4 metrics together with their median values shown as the dashed lines. Notice that there is a tendency for the probability of a correct classification to increase over time and for the probability of an incorrect classification to decrease over time, presumably because of the increasing effectiveness of the smoothing operation in decreasing fluctuations in model parameter values. There exists a periodicity effect in traffic models' classification accuracy as evidenced by the fact that' classification accuracy is typically higher during the 16:00 UTC time period (see FIG. 10). The median values for each of these 4 metrics are given in FIG. 9.

FIGS. 7-10 are based on a seasonality cycle of 1 week duration with 3 time periods per day resulting in 21 successive 8-hour periods. However, other seasonality cycles may be implemented, as, for example, successive 4-hour periods within a week, resulting in 42 successive 4-hour periods.

### SUMMARY

The disclosed technology presents an approach for detecting E-mail Spammers based on SMTP traffic transport header data. The approach consists of establishing SMTP traffic models of legitimate vs. spammer SMTP Clients and then classifying an “unknown” SMTP Client with respect to his/her current SMTP traffic distance from these models' mean value vectors. A periodicity effect also exists for SMTP traffic initiated by legitimate SMTP Clients and the traffic model parameter values can be adjusted for this periodicity using EWMA smoothing. Given adjusted model parameter values, the accuracy of this approach in classifying known Black Listed and White Listed SMTP Clients is improved.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A system for detecting Email spammers comprising:
a database containing a byte size and variability traffic flow model, the byte size and variability traffic flow model representing byte size and variability of traffic flows associated with a plurality of known SMTP Clients; and
a classification system classifying incoming traffic flows initiated by an unknown SMTP Client based on a comparison between byte size and variability of the incoming traffic flows and the byte size and variability traffic flow model.

2. The system for detecting Email spammers as claimed in claim 1 wherein the plurality of known SMTP Clients are legitimate SMTP Clients and spammer SMTP Clients.

3. The system for detecting Email spammers as claimed in claim 2 wherein the unknown SMTP Client initiating SMTP traffic flows is classified as an Email spammer, a legitimate SMTP client or unclassifiable.

4. The system for detecting Email spammers as claimed in claim 2 wherein the byte size and variability traffic flow model identifies a mean byte size for traffic flows associated with the plurality of legitimate SMTP Clients and identifies a mean byte size for traffic flows associated with the plurality of Spammer SMTP Clients.

5. The system for detecting Email spammers as claimed in claim 2 wherein the byte size and traffic variability traffic flow model identifies a standard deviation in byte size for traffic flows associated with the plurality of legitimate SMTP Clients and identifies standard deviation in byte size for traffic flows associated with the plurality of Spammer SMTP Clients.

6. The system for detecting E-mail Spammers as claimed in claim 2 wherein the byte size and traffic variability traffic flow model identifies a multivariate traffic vector based on a mean byte size and a standard deviation in byte size for traffic flows associated with the plurality of legitimate SMTP Clients and identifies a multivariate traffic vector based on a mean byte size and a standard deviation in byte size for traffic flows associated with the plurality of Spammer SMTP Clients.

7. The system for detecting Email Spammers as claimed in claim 1 further comprising:
an extractor for extracting the byte size and variability from traffic flow data associated with the incoming traffic flows initiated by the unknown SMTP Client.

8. The system for detecting Email Spammers as claimed in claim 7 further comprising:
a comparator for comparing the byte size and variability of the incoming traffic flows initiated by the unknown SMTP Client with the byte size and variability traffic flow model.

9. The system for detecting Email Spammers as claimed in claim 8 further comprising:
a storage device containing a classification algorithm for classifying an unknown SMTP Client initiating SMTP traffic flows based on the results of the comparator.

10. The system for detecting Email Spammers as claimed in claim 2 further comprising:
a filter for filtering traffic flows associated with an SMTP client classified as an Email spammer from a message system.

11. The system for detecting Email Spammers as claimed in claim 2 further comprising:
an identifier for identifying and blacklisting an SMTP client classified as an Email spammer within a message system.

12. The system for detecting Email Spammers as claimed in claim 1 further comprising:
a traffic model adjustor for adjusting the byte size and variability traffic flow model based on a periodicity effect.

13. The system for detecting Email Spammers as claimed in claim 12 wherein the traffic model adjustor uses a smoothing technique to smooth the byte size and variability traffic flow model.

14. A method for detecting Email Spammers comprising:
comparing byte size and traffic variability of incoming traffic flows initiated by an SMTP Client to a byte size and variability traffic flow model; and
classifying an SMTP Client using the incoming traffic flows initiated by the SMTP Client based on the comparing step.

15. The method as claimed in claim 14 wherein the SMTP Client is classified as an Email spammer, a legitimate Email client or unclassifiable based on the SMTP Client's incoming flows.

16. The method as claimed in claim 14 wherein the byte size and traffic variability traffic flow model identifies a mean byte size for traffic flows associated with the plurality of legitimate SMTP Clients and with the plurality of spammer SMTP Clients.

17. The method as claimed in claim 14 wherein the byte size and traffic variability traffic flow model identifies a standard deviation in byte size for traffic flows associated with the plurality of legitimate SMTP Clients and with the plurality of spammer SMTP Clients.

18. The method as claimed in claim 14 wherein the byte size and traffic variability traffic flow model identifies a multivariate traffic vector based on a mean byte size and a standard deviation in byte size for traffic flows associated with the plurality of legitimate SMTP Clients and with the plurality of spammer SMTP Clients.

19. The method as claimed in claim 14 further comprising the step of:
extracting the byte size and variability from traffic header information associated with the incoming traffic flows of an SMTP Client.

20. The method as claimed in claim 19 further comprising the step of:
comparing the byte size and variability of the incoming traffic flows associated with an SMTP Client with the byte size and variability traffic flow model.

21. The method as claimed in claim 20 further comprising the step of:
classifying a SMTP Client using the incoming traffic flows initiated by the SMTP Client based on the results of the comparing step.

22. The method as claimed in claim 15 further comprising the step of:
filtering SMTP traffic flows associated with an SMTP Client classified as an Email Spammer from a message system.

23. The method as claimed in claim 15 further comprising the step of:
identifying and blacklisting a SMTP Client classified as Email Spammer within a message system.

24. The method as claimed in claim 14 further comprising the step of:
adjusting the byte size and variability traffic flow model based on a periodicity effect.

25. The method as claimed in claim 24 wherein the adjusting step uses a smoothing technique to smooth the byte size and variability traffic flow model.
